(19) United States
(12) Patent Application Publication
(10) Pub. No.: US 2004/0022447 A1
(43) Pub. Date: Feb. 5, 2004

(54) Method and system for image compression and decompression using span of interest of an imaging sequence

(75) Inventors: Sudipta Mukhopadhyay, Bangalore (IN); Soma Sekhar Dhavala, Bangalore (IN); Lalitha Manikya Eswara, Bangalore (IN)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company, Niskayuna, NY

(21) Appl. No.: 10/064,620

(22) Filed: Jul. 31, 2002

(51) Int. Cl. G06K 9/36

(52) U.S. Cl. 382/243; 382/244

(57) ABSTRACT

A system and method for image compression and decompression is provided. The method of image compression and decompression includes selecting a portion of image in a span of interest obtained from an acquired imaging sequence; applying lossless compression to the portion of image in a span of interest and obtaining a compressed image sequence; and applying decompression to the compressed image sequence and obtaining therefrom an analytically relevant image sequence.

### BACKGROUND OF INVENTION

The present invention relates generally to an image compression and decompression technique and specifically to a method and a system for image compression and decompression using a span of interest of an imaging sequence.

There are two broad techniques for image compression, lossy and lossless compression. Both techniques have certain limitations. Lossy compression achieves high compression ratios but loses some information and hence the image quality suffers. In lossless compression, the image is intact but the compression ratios are low.

In certain imaging applications, for example in medical imaging, there is a need for both precise images and higher compression ratios. In other imaging applications like satellite imaging, video broadcasting and industrial imaging, for example, precise images may or may not be essential.

In imaging, several techniques for detecting or reconstructing region of interest exist based on the specific application or use. Typical applications include, for example, medical applications for diagnostic purposes, viewer satisfaction in the case of multimedia applications, or image compression in medical, or satellite applications or other industrial imaging applications like pipeline inspection, aircraft fuselage inspection. These techniques can be viewed in generic terms as imaging techniques.

Some of the existing image selection techniques include thresholding; edge detection based region identification followed by connected contour analysis; and, morphological operator based algorithms. If the image sequence has two dimensional or three-dimensional (2D or 3D, respectively) region-of-interests (ROIs) which can be identified based on the their properties which are significantly different from their surroundings, then many known segmentation based algorithms to extract the ROls can be used. Again, there are various ways in which segmentation can be done.

Two major approaches for segmentation are edge detection and morphological operator method. In edge detection, in a simplistic setting, a transition in the intensity value is located that is defined as an edge. After this operation has been done on the entire image, the detected edges are classified to be significant or insignificant based on a threshold. Once a final map of the edges is determined and computed, the connected contour analysis follows, wherein the edges that are continuous are located. The region surrounded by the contour is considered as ROI. The same is applicable in 3D also. The morphological operators are unconventional signal processing tools which exploit the geometric properties or characteristics of the signal or an image. There are many “morphological” operators available in literature like connected operators, watershed transformation, geodesic skeleton, morphological interpolation etc. Connected operators have been successfully used in image segmentation and also for image coding for compression. These operators can be used to reproduce an object (a segmented image that is geometrically closed) which is the ROI.

These techniques mostly rely on the complete image for detecting or reconstructing the region of interest and do not look at analytically important region which can be selected frame by frame. Since the compression is applied on the complete image, it is difficult to achieve higher compression ratios and in cases where lossless compression is applied the compression ratios are low resulting in large computation time and slow transmission. In cases where lossy compression can be applied like in industrial imaging applications, there is always a need to improve the compression ratios.

It is therefore desirable to have a technique which can result in lossless compression with higher compression ratios of the important and relevant imaging information which will result in faster decoding and reduction in transmission time for an image over a network. The same technique if applied to applications requiring lossy compression will further enhance the speed and transmission of the images.

### SUMMARY OF INVENTION

Briefly, in accordance with a first aspect of the invention, a method of image compression and decompression comprises selecting a portion of image in a span of interest obtained from an acquired imaging sequence; applying lossless compression to the portion of image for obtaining a compressed image sequence; and, applying decompression to the compressed image sequence and obtaining therefrom an analytically relevant image sequence.

In accordance with a second aspect, a method of image compression and decompression for images obtained by an imaging device comprises selecting a portion of image of a span of interest obtained from the device; applying lossless compression to the portion of image and obtaining therefrom a compressed image sequence; and, applying decompression to the compressed image sequence and obtaining therefrom an analytically relevant image sequence.

In accordance with a third aspect, a method of image compression and decompression comprises selecting a portion of an image in a span of interest obtained from an acquired imaging sequence; applying lossy compression to the portion of the image in a span of interest and obtaining a compressed image sequence; and, applying decompression to the compressed image sequence and obtaining therefrom an analytically relevant image sequence.

In accordance with a fourth aspect, an image processing system comprises a span of interest definer block for selecting a portion of image in a span of interest from an imaging sequence; an image compression block for compressing the portion of image in a span of interest; and, an image decompression block for decompressing and reconstructing an analytically relevant image sequence.

In accordance with a fifth aspect, a machine readable medium for storing computer program code comprises means for selecting a portion of image in a span of interest obtained from an acquired imaging sequence; applying lossless compression to the portion of image in a span of interest and obtaining a compressed image sequence; and, applying decompression to the compressed image sequence and obtaining therefrom an analytically relevant image sequence.

In accordance with a sixth aspect, a computer program encoded on a machine readable medium comprises an algorithm for selecting a portion of image in a span of interest obtained from an acquired imaging sequence; applying lossless compression to the portion of image in a span of interest and obtaining a compressed image sequence; and, applying decompression to the compressed image sequence and obtaining therefrom an analytically relevant image sequence.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a flow chart for a method of image compression and decompression according to embodiments of the invention;

FIG. 2 illustrates a table for a span of interest in time for an eight x ray cine angiogram;

FIG. 3 illustrates a frame of x ray cine angiogram sequence including: (a) an original image; (b) a binary mask for the x ray cine angiogram sequence; (c) an image after the mask is applied; and, (d) an image outside the mask; and,

FIG. 4 illustrates a table for compression ratios for eight x ray cine angiogram.

### DETAILED DESCRIPTION

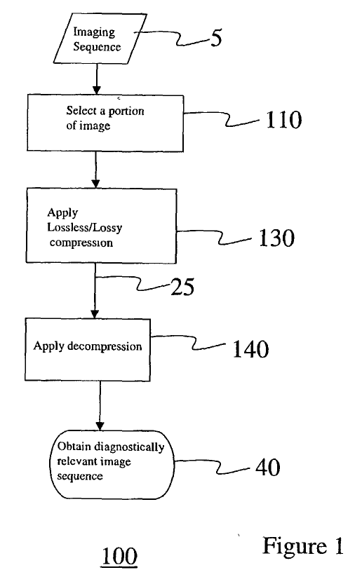

Referring to FIG. 1, a method of image compression and decompression is provided. The method includes selection of a portion of image in a span of interest (shown by span of interest definer block 110 in FIG. 1) obtained from an acquired imaging sequence 5. Lossless compression is applied (shown by image compression block 130 in FIG. 1) to the portion of the image in the span of interest and a compressed image sequence 25 is obtained. At the next step, decompression is applied (shown by image decompression block 140 in FIG. 1) to the compressed image sequence 25 to obtain therefrom an analytically relevant image sequence 40. After decompression, the resulting image maintains the information in the span of interest (both in space and time) intact, but sacrifices the other information.

The frames of data acquired from the acquired imaging sequence 5 may be obtained from a number of existing imaging techniques, for example but not limited to magnetic resonance imaging (MRI), x ray, x ray angiogram, computed tomography (CT), ultrasound and non medical imaging techniques to which image compression and decompression are commonly used, e.g. multi media and communciation, fault detection and inspection techniques in industrial applications. As used herein, a portion of image is defined as a subset or part of an image comprising at least one frame or a plurality of frames. Image, as used herein is a two dimensional (2D) or a three dimensional (3D) distribution of pixels. Frame as used herein is defined as snapshot, or alternatively a single image for the imaging technique being used, of a part of an image. Also, as used herein, a span of interest is defined as a spatial and a temporal region of interest which may include the region of interest in time or the region of interest in space or the region of interest both in space and time. Further, as used herein, lossless compression is defined as a compression technique where the desired image remains intact along with achieving high compression ratios to facilitate greater speed of tramsmission.

In lossless compression, typically the input image remains intact, but the compression ratios achieved are much lower. Compression technologies used in certain applications, e.g medical applications, require a high degree of preciseness and accuracy. No alteration or loss of information is acceptable as their main utilization is for diagnostic purposes. The image compression and decompression method as described above ensures the utilization of the image of interest confined within comparatively small space and time (span of interest). The lossless compression methods described herein focus on this space and time images of interest. This focus has two advantages. The first advantage is achieving higher compression ratios, as the data to be compressed is within a region in the image/video sequences. Higher compression ratios not only result in lesser storage space, but also reduce transmission time for image/video over a network supporting the image processing. The second advantage is of lower complexity of this method. As the compression algorithm works in a smaller region in the image, number of pixels to be dealt with is lesser, and this certainly results in faster decoding (decompression), irrespective of choice of the decoder. The method discribed hereinabove addresses faster coding speeds and higher compression ratios simultaneously. Typical compression techniques use transform or prediction based techniques for encoding for example, wavelet transforms, discrete cosine transform (DCT) and other known encoding techniques, then apply entropy coding e.g Hauffman, Arithmatic or Run length coding to get a compressed bit stream (compressed image sequence).

Once lossless compression is completed, then decompression is applied to the output of the compression step (the compressed image sequence). Applying the decompression as described above results in obtaining an analytically relevant image sequence. Analytically relevant image as used herein is defined as the useful portion of the complete image which is necessary for analysis purposes. In specific embodiments of this invention relating to medical devices, an analytically relevant image sequence means a diagnostically relevant image sequence useful for diagnostic purposes. The decompression step typically involves inverse operation of the compression step, so entropy decoding is applied on the compressed bit stream and then using inverse transform or inverse prediction techniques, the analytically relevant image sequence is obtained.

There are various options for selecting the portion of image in the span of interest definer block 110. In one embodiment, a span of interest definer block 110 selects at least one frame in a span of interest obtained from an acquired imaging sequence 5. The steps of lossless compression and decompression remain the same as explained in reference to FIG. 1. Selecting at least one frame is useful in x ray and MRI imaging.

In an alternative embodiment, a method for selecting a portion of image includes selecting a plurality of frames in a span of interest. In a more specific embodiment, selecting a plurality of frames includes selecting the plurality of frames in time sequence and in space sequence. As used herein, time sequence refers to images taken over time and space sequence refers to 2D/3D slices which are used to reconstruct the complete image. In an alternative embodiment, the selection of a plurality of frames in a span of interest includes either selecting the frames in time sequence or in space sequence. The steps of applying lossless compression and decompression to obtain the analytically relevant image sequence remain the same as explained in reference to FIG. 1.

In another embodiment, selection of a plurality of frames in a span of interest includes selecting at least two time instances and capturing the frames in the span of interest between the two time instances. This embodiment is particularly useful in x ray angiogram applications to capture relevant images during the time frame when a contrast agent or an imaging dye is injected and tracked within a subject. In this example, selection of at least two time instances includes the selection of at least one time instance when a dye appears and capturing a second time instance when the dye disappears. Angiography involves injection of a contrast agent into blood vessels to increase their visibility against surrounding tissues in a x ray image. In case of the x ray cin é-angiogram, the frames of interest originate from the point of contrast agent injection to the point where it disappears. As a first step, the span of interest in time, based on the two time instances is identified and only the frames within that interval are considered for further processing. The second step involves the assumption that the information pertaining to x ray angiography is limited to the circular zone of a collimator ring of the x ray angiogram system and therefore the circular zone is the region that is selected. It is to be appreciated that focusing the image compression methods described herein within the the circular zone will reduce the number of image data elements to be processed. This further reduces the computational complexity and bits for storage. Combining the above mentioned observations while developing a compression algorithm results in better speed and compression ratios simultaneously.

Another embodiment for selecting a portion of the image includes having a user select option for manual or automatic selection of a plurality of frames in a span of interest. In one aspect, the user select option includes segmenting an identifiable anatomy of a patient . Another alternative for the user select option includes manually marking the frames of interest. Yet another alternative of the user select option comprises sketch-gripping an image boundary which is a method where the user roughly outlines the region of interest and the algorithims work at the back end to pull out the relevant image of interest which is within the outlined portion . These user select options can be applied to different imaging techniques like x rays, x ray angiogram, MRI, CT, ultrasound imaging and other non medical imaging techniques In a specific example using a MRI system, the selection of a plurality of frames is done using automatic edge detection techniques for selecting the frames of interest in a space sequence. In another specific example of using ultrasound imaging, at least one frame in the span of interest includes the selection of a fan shaped image using automatic means or alternately manual means.

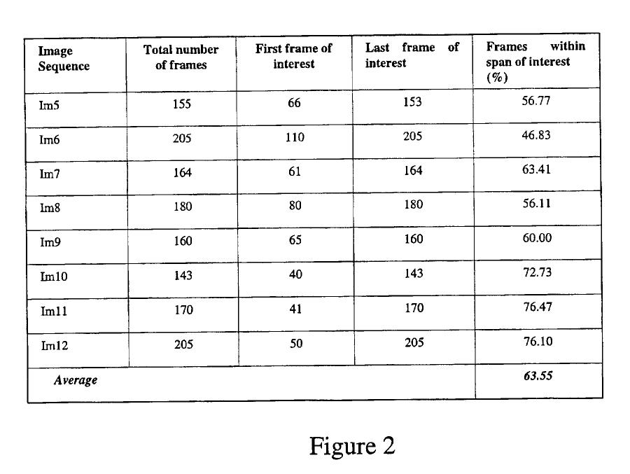

FIG. 2 gives exemplary results of this method of image compression and decompression for eight x ray cin é-angiogram image sequences. The table illustrated in the FIG. 2 gives the total number of frames present in the sequence, the first frame (where the contrast agent appears first time instance) and last frame (where the contrast agent disappears- second time instance, or the last frame in the sequence) of interest, and also the percentage of frames present in the span of interest in time. It is observed that the span of interest in time on an average is 63.55% of the total sequence. This reduces the data set and computations by 36.45%. Hence the effective compression ratio and speed increases by 57.36%.

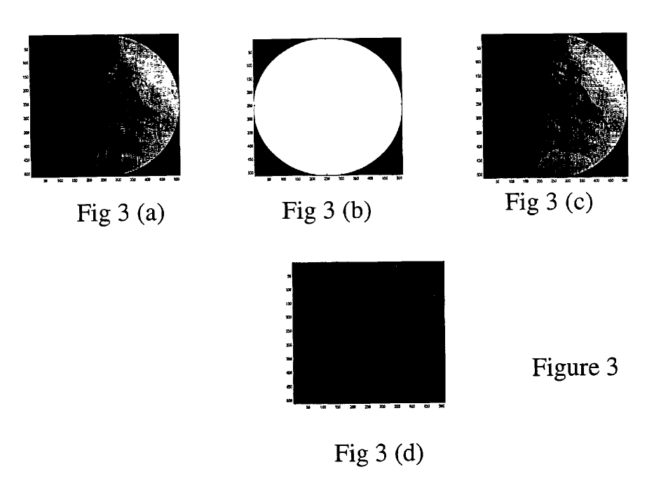

Referring to FIG. 3, there is shown an exemplary method for selecting a circular region of interest. As shown, a binary mask that encompasses the circular region in the images is defined. FIG. 3(a) shows an original x ray angiogram image, FIG. 3(b) shows a binary mask defined image, FIG. 3(c) shows a reconstructed image (lossless within the defined shape) and FIG. 3(d) shows the information that is not considered for encoding. For x ray cin é-angiograms, the mask is fixed. It is a circular region centered at the middle of the frame and touching the four sides of the image rectangle. Hence, it need not be stored or transmitted separately. In one aspect, the encoding process involves application of a (2,2) integer wavelet transform using lifting scheme with decomposition up to first level. Any integer wavelet may be used for encoding purposes. Wavelet transform provides multi resolution and integer wavelet transform further avoids floating point computation and ensures that the image can be reconstructed back without any error as is known in the art. The wavelet transform, implemented for the circular region is a ROI based wavelet scheme. Wavelet transforms are implemented in the conventional approach using filtering results in floating point (non-integer) values. Coding these coefficients results in rounding-off to the nearest integer, thereby inducing loss in the transmitted images. Hence for lossless coding, characterizing wavelet transforms using lifting scheme that map integers to integers is implemented in this method . Wavelet transform allows to choose appropriate basis function for the application. The (2,2) and (4,2) interpolating wavelets resulted in low entropy value when applied on for x-ray images. First order entropy of the transform coefficients is calculated that gives the number of bits required to encode the information of interest. The product of entropy and the number of coefficients gives the estimate of the number of bits required, which when divided by the number of bits per frame gives the estimate of the achieved compression ratio (CR). This method of compression would work for any integer wavelet.

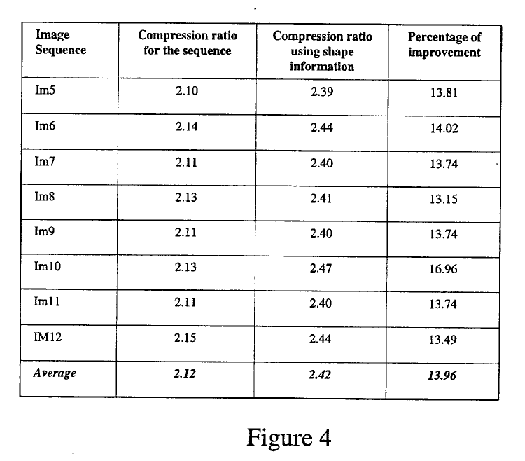

The compression ratios for the full frame image sequence and cropped image sequence (limited within the collimator ring) are tabulated in the table in, FIG. 4. The compression ratios indicated are averaged compression ratios achieved within the span of interest in time. The effective increase of the compression ratio is 13.96% on an average. As the number of elements within the collimator ring is 78.83% of the full frame sequence, the computations reduce by 21.17% leading to an increase of speed by 26.86%.

For an image sequence like that from the x ray cin é-angiogram where the span of the interest is limited both in time and area, the benefits reinforce each other. The effective computation is 50.1% (0.6355×0.7883×100) of the total, resulting in doubling the speed of decoder. In the same way the effective compression ratio improves by 79.32% ((1.1396×1.5736 1)×100).

In another exemplary embodiment, a MRI imaging device is used for acquiring an imaging sequence 5 of FIG. 1, and a binary mask is applied for the MRI image under consideration (it is an irregular portion in case of MRI). The percentage of pixels within the mask is 47.37% therefore the span of interest based algorithim needs only 47.37% of calculations to perform encoding and decoding when compared to an algorithim working on the whole frame. This leads to 111% improvement in the speed.

In yet another exemplary embodiment, an ultrasound imaging device is used for acquiring an imaging sequence 5 of FIG. 1, and a binary mask is applied for the ultrasound image under consideration (it is a fan shaped image). For the 480×640 eight bit image, the total number of pixels in the frame is 480×640=307200 and the number of pixels with the mask is 109451 i.e. 35.62% of the full frame. It gives a speed increment of 180%.

While the embodiments described above perform image compression and decompression for 2D/3D images obtained by medical imaging devices, for example x ray, x ray angiogram, MRI, CT, and ultrasound, the embodiments are equally applicable in a four-dimensional (4D) scenario, for example for 4D ultrasound imaging techniques. As used herein, 4D ultrasound imaging acquires images in the x, y, z conventional axes in real time. In the 4D scenario, the volume of the image is considered and the diagnostically important portion of the volume is cropped and stored, such cropped portions are stored over time and it leads to savings in storage space. It is also to be appreciated that embodiments of the present invention are applicable to many other imaging schemes to which compression and decompression are applicable. For example, in satellite imaging, if a certain object is of interest, a central image processing computer can detect the frames which contains the target object and keep only that portion of the image in the relevant frames. Employing methods described herein will reduce the compressed file size and hence transmission time from satellite to ground station. Further, method described herein could be used for defence purposes, weather forecasting, geological imaging for detecting natural resources and other satellite applications. Embodiments of the present invention will also be applicable to industrial imaging applications, for example, fault detection in pipeline inspections and in aircraft fuselage inspections. In case of multimedia applications, video-conferencing or web casting, the same approach can also be used. For example, in news broadcasting, the important image is of the person on the screen. If the background is deleted, it reduces a lot of data and hence can help compression and transmission of such video in constrained bandwidth environment.

In an alternative embodiment, lossy compression is applied to a portion of image in a span of interest obtained from an acquired imaging sequence and compressed image sequence is obtained and then as discussed in reference with other embodiments hereinabove, decompression is applied to the compressed image sequence to obtain thereform an analytically relevant image sequence. Some of the imaging applications discussed hereinabove permit the use of lossy compression in the region of interest, for example multi-media applications or certain satellite applications or fault detection applications. In these applications precision and accuracy of the image may not be too critical and hence they allow the use of lossy compression where compression ratios are high. This method can be applied to these applications requiring lossy compression resulting in even better compression performance (higher compresion ratios) and eventually greater speed of transmission and lesser storage area.

One aspect of the method of image compression and decompression includes archiving the analytically relevant image sequence. Archiving may be done for detailed diagnosis for treatment purposes or for use in education or research.

Referring again to FIG. 1, a specific embodiment of the invention is an imaging system 100 comprising a span of interest definer block 110 for selecting a portion of image (a plurality of frames or alternately at least one frame of interest) from an imaging sequence 5; an image compression block 130 for compressing the portion of image from the selected plurality of frames of interest; and, an image decompression block 140 for decompressing and reconstructing the image to obtain an analytically relevant image sequence 40.

The embodiments of the invention can also be embodied in the form of computer-implemented processes and apparatuses for practicing those processes.

The present invention can also be embodied in the form of computer program code containing instructions embodied in tangible media, such as floppy diskettes, CD-ROMs, hard drives, or any other computer readable storage medium, wherein when the computer program code is loaded into and executed by a computer, the computer becomes an apparatus for practicing the invention. The present invention can also be embodied in the form of computer program code, for example, whether stored in a storage medium, loaded into or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing the invention. When implemented on a general purpose microprocessor, the computer program code segments configure the microprocessor to create specific logic circuits. While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of image compression and decompression comprising:
selecting a portion of an image in a span of interest obtained from an acquired imaging sequence;
applying lossless compression to the portion of the image in a span of interest and obtaining a compressed image sequence; and,
applying decompression to the compressed image sequence and obtaining therefrom an analytically relevant image sequence.

2. The method of claim 1, wherein the portion of the image is a plurality of frames in a span of interest.

3. The method of claim 1, wherein the portion is at least one frame in a span of interest.

4. The method of claim 1 further comprises archiving the analytically relevant image sequence.

5. The method of claim 1, wherein selecting the portion in the span of interest comprises having a user select option for selecting the portion of image.

6. The method of claim 5, wherein the user select option comprises segmenting an identifiable anatomy of a patient.

7. The method of claim 5, wherein the user select option comprises manually marking frames of interest.

8. The method of claim 5, wherein the user select option comprises sketch-gripping an image boundary.

9. The method of claim 1, wherein selecting the portion of image in the span of interest comprises:
selecting the portion of the image in a time sequence; and
selecting the portion of the image in a space sequence.

10. The method of claim 1, wherein selecting the portion of the image in the span of interest comprises selecting the portion of image in a time sequence.

11. The method of claim 1, wherein selecting the portion of the image in the span of interest comprises selecting the portion of image in a space sequence.

12. A method of image compression and decompression for images obtained by an imaging device, comprising:
selecting a portion of an image of a span of interest obtained from the device;
applying lossless compression to the portion of the image and obtaining therefrom a compressed image sequence; and,
applying decompression to the compressed image sequence and obtaining therefrom an analytically relevant image sequence.

13. The method of claim 12, wherein the imaging device is a medical imaging device selected from a magnetic resonance imaging system, a computed tomography system, an x ray system, an x ray angiogram system and an ultrasound system.

14. A method of image compression and decompression for images obtained by a x ray device, comprising:
selecting at least one frame of interest obtained from the x ray device;
applying lossless compression to the at least one frame of interest and obtaining therefrom a compressed image sequence; and,
applying decompression to the compressed image sequence and obtaining therefrom an analytically relevant image sequence.

15. A method of image compression and decompression for images obtained by a x-ray angiogram device, comprising:
selecting a plurality of frames of interest obtained from the x ray angiogram;
applying lossless compression to the plurality of frames of interest and obtaining therefrom a compressed image sequence; and,
applying decompression to the compressed image sequence and obtaining therefrom an analytically relevant image sequence,
wherein selecting the plurality of frames of interest comprises selecting at least two time instances and capturing the frames of interest between the two time instances.

16. The method of claim 15, wherein selecting at least two time instances comprises selecting at least one time instance when a dye appears and capturing a second time instance when the dye disappears.

17. A method of image compression and decompression for images obtained by a MRI device, comprising:
selecting a plurality of frames of interest obtained from a MRI device;
applying lossless compression to the plurality of frames of interest and obtaining a compressed image sequence; and
applying decompression to the compressed image data and obtaining an analytically relevant image sequence.

18. The method of claim 17, wherein selecting the plurality of frames of interest comprises using a user select option for manually selecting the frames of interest in a space sequence.

19. A method of claim 17, wherein selecting the plurality of frames of interest comprises using automatic edge detection techniques for selecting the frames of interest in a space sequence.

20. A method of image compression and decompression for images obtained by an ultrasound system, comprising:
selecting at least one frame of interest obtained from the ultrasound device;
applying lossless compression to the least one frame of interest and obtaining a compressed image sequence; and
applying decompression to the compressed image sequence and obtaining an analytically relevant image sequence.

21. The method of claim 20, wherein selecting the at least one frame of interest comprises selecting a fan shaped image using automatic means.

22. The method of claim 20, wherein selecting the at least one frame of interest comprises selecting a fan shaped image using manual means.

23. A method of image compression and decompression comprising:
selecting a portion of an image in a span of interest obtained from an acquired imaging sequence;
applying lossy compression to the portion of the image in a span of interest and obtaining a compressed image sequence; and,
applying decompression to the compressed image sequence and obtaining therefrom an analytically relevant image sequence.

24. An imaging system comprising:
a span of interest definer block for selecting a portion of an image in a span of interest from an imaging sequence;
an image compression block for compressing the portion of the image in the span of interest; and,
an image decompression block for decompressing and reconstructing the image.

25. The imaging system of claim 24, wherein the portion of the image is at least one frame in a span of interest.

26. The imaging system of claim 24, wherein the portion of the image is plurality of frames in a span of interest.

27. The imaging system of claim 26, wherein the plurality of frames comprise frames of interest in time sequence; and frames of interest in space sequence.

28. An imaging system of claim 26, wherein the plurality of frames comprise frames of interest in a time sequence.

29. An imaging system of claim 26,wherein the plurality of frames comprise frames of interest in a space sequence.

30. A machine readable medium for storing computer program code comprising means for:
selecting a portion of an image in a span of interest obtained from an acquired imaging sequence;
applying lossless compression to the portion of the image in a span of interest and obtaining a compressed image sequence; and,
applying decompression to the compressed image sequence and obtaining therefrom an analytically relevant image sequence.

31. A computer program encoded on a machine readable medium comprising an algorithm for:
selecting a portion of an image in a span of interest obtained from an acquired imaging sequence;
applying lossless compression to the portion of the image in a span of interest and obtaining a compressed image sequence; and,
applying decompression to the compressed image sequence and obtaining therefrom an analytically relevant image sequence.
